(19) United States
(12) Patent Application Publication
(10) Pub. No.: US 2025/0199502 A1
(43) Pub. Date: Jun. 19, 2025

(54) DATA COLLECTING DEVICE AND COMPUTER-READABLE STORAGE MEDIUM

(71) Applicant: FANUC CORPORATION, Yamanashi (JP)

(72) Inventors: Tomokazu KATO, Yamanashi (JP); Makoto HAGA, Yamanashi (JP)

(21) Appl. No.: 18/837,886

(22) PCT Filed: Mar. 1, 2022
(86) PCT No.: PCT/JP2022/008599

§ 371 Date: Mar. 4, 2025

(51) Int. Cl. G05B 19/406

(52) U.S. Cl. CPC G05B 19/406

(57) ABSTRACT

A data collecting device including: a condition determining unit for determining whether an industrial machine is in operation; and a data collecting unit for collecting data from a numerical control device for controlling the industrial machine when the condition determining unit determines that the industrial machine is not in operation.

### TECHNICAL FIELD

The present disclosure relates to a data collecting device and a computer-readable storage medium.

### BACKGROUND ART

In recent years, various types of data have been acquired from an industrial machine or a numerical controller that controls the industrial machine, in order to be utilized for maintenance and management of the industrial machine. For example, various parameters set in the numerical controller, various types of setting data, a machining program, data indicating an operation history for the numerical controller, operation data of the industrial machine, and other similar data are acquired (for example, Patent Literature 1). These pieces of data are generally set in a data collecting device to be acquired at a time determined in advance.

### CITATION LIST

### Patent Literature

Patent Literature 1: JP 2019-109697 A

### SUMMARY OF INVENTION

### Technical Problem

However, an access to these types of data stored or processed by the numerical controller may be restricted during an operation of an industrial machine. Therefore, there is a concern that it is not possible to collect a portion or the entirety of the data to be collected in advance.

In addition, an access from an industrial machine to these types of data may be restricted during data collection. In this case, there is a concern that the operation of the industrial machine is not performed normally.

Thus, a data collecting device that is capable of reliably collecting data and does not have an adverse influence on the operation of an industrial machine is required.

### Solution to Problem

A data collecting device includes a condition determiner that determines whether or not an industrial machine is in operation, and a data collector that collects data from a numerical controller that controls the industrial machine, in a case where the condition determiner determines that the industrial machine is not in operation.

A computer-readable storage medium stores instructions for causing a computer to execute determining whether or not an industrial machine is in operation, and collecting data from a numerical controller that controls the industrial machine, in a case where it is determined that the industrial machine is not in operation.

### Advantageous Effects of Invention

According to an aspect of the present disclosure, the data collecting device can reliably collect data.

### BRIEF DESCRIPTION OF DRAWINGS

FIG. 1 is a block diagram illustrating an example of a hardware configuration of a data collecting device.

FIG. 2 is a block diagram illustrating an example of functions of the data collecting device.

FIG. 3 is a flowchart illustrating an example of processes executed by data collecting device.

FIG. 4 is a block diagram illustrating another example of functions of the data collecting device.

FIG. 5 is a flowchart illustrating another example of processes executed by the data collecting device.

FIG. 6 is a diagram illustrating an example of a hardware configuration of an industrial machine.

### DESCRIPTION OF EMBODIMENTS

Hereinafter, a data collecting device according to an embodiment of the present disclosure will be described with reference to the drawings. Note that not all combinations of features described in the following embodiment are necessarily required for solving the problem. Furthermore, the unnecessarily detailed description may be omitted. In addition, the following description of the embodiment and the drawings are provided for those skilled in the art to fully understand the present disclosure, and are not intended to limit the scope of the claims.

The data collecting device is a device for collecting data from a numerical controller that controls an industrial machine. Examples of the industrial machine include a machine tool, an electric discharge machine, and an industrial robot. Examples of the machine tool include a machining center, a lathe, and a combined processing machine. Examples of the electric discharge machine include a wire electric discharge machine and an engraving electric discharge machine. Examples of the industrial robot include a manipulator.

Examples of the data collected by the data collecting device include data set for various parameters, a machining program, data indicating an operation history of an operation on the numerical controller, and data indicating an operation status of the numerical controller. These types of data are referred to as internal data. The internal data may include data such as a tool offset, a tool position, a cutting time, a tool use time, and a fast-forward time.

The data collecting device is mounted on, for example, a server, a personal computer (PC), a tablet terminal, and a smartphone connected to the numerical controller. The data collecting device is connected to the numerical controller via a network. The network is, for example, a local area network (LAN) and an Internet line.

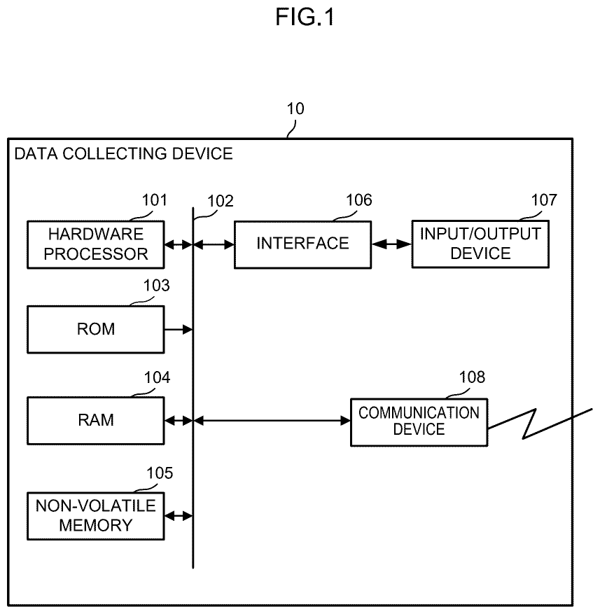

FIG. 1 is a diagram illustrating an example of a hardware configuration of the data collecting device. A data collecting device 10 includes a hardware processor 101, a bus 102, a read only memory (ROM) 103, a random access memory (RAM) 104, a non-volatile memory 105, an interface 106, an input/output device 107, and a communication device 108.

The hardware processor 101 is a processor for controlling the entire data collecting device 10 in accordance with a system program. The hardware processor 101 reads the system program and the like stored in the ROM 103 via the bus 102. The hardware processor 101 is, for example, a central processing unit (CPU) or an electronic circuit.

The bus 102 is a communication path that connects the pieces of hardware in the data collecting device 10 to each other. Each piece of hardware in the data collecting device 10 transmits and receives data via the bus 102.

The ROM 103 is a storage device which can store the system program and the like for controlling the entire data collecting device 10. The ROM 103 may store a program for data collection. The ROM 103 is a computer-readable storage medium.

The RAM 104 is a storage device that temporarily stores various types of data. The RAM 104 functions as a work area for the hardware processor 101 to process various types of data.

The non-volatile memory 105 is a storage device for holding data even in a state where the data collecting device 10 is powered off. The non-volatile memory 105 stores, for example, collected data. The non-volatile memory 105 is a computer-readable storage medium. The non-volatile memory 105 is configured by, for example, a memory backed up by a battery or a solid state drive (SSD).

The interface 106 is a communication path that connects the bus 102 and the input/output device 107. The interface 106 transmits data processed by the hardware processor 101 to the input/output device 107. In addition, the interface 106 transmits data input from the input/output device 107 to the hardware processor 101.

The input/output device 107 is a device for outputting various types of data and receiving inputs of various types of data. The output is to display various types of data on a display screen. The input/output device 107 includes a display, a keyboard, a touch panel, and a mouse.

The communication device 108 is a device provided for communicating between the data collecting device 10 and an external device. Here, the external device is, for example, a numerical controller that controls an industrial machine. The communication device 108 communicates with one or more external devices. The communication device 108 communicates with the numerical controller via a network.

Next, functions of the data collecting device 10 will be described.

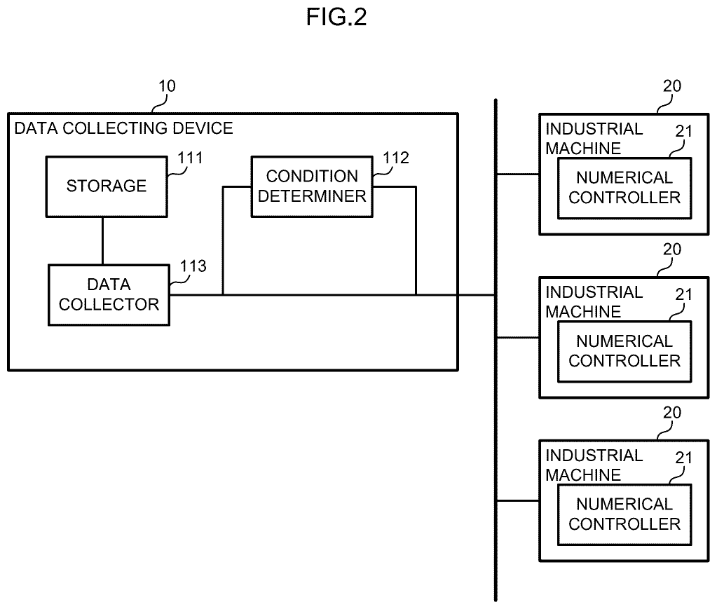

FIG. 2 is a block diagram illustrating an example of functions of the data collecting device 10. The data collecting device 10 includes a storage 111, a condition determiner 112, and a data collector 113.

The storage 111 is actualized by storing various types of data in the RAM 104 or the non-volatile memory 105. The condition determiner 112 and the data collector 113 are actualized, for example, in a manner that the hardware processor 101 performs arithmetic processing by using the system program stored in the ROM 103 and various types of data stored in the non-volatile memory 105.

The storage 111 stores a list of data to be collected and a data collection time at which data is collected from the numerical controller 21. The list of data includes one or more items of data to be collected. The items include, for example, various parameters, a machining program, data indicating an operation history, and data indicating an operation status.

The data collection time is a time at which the data collector 113 collects data from the numerical controller 21. The storage 111 may store the data collection time in association with each item of the list of data. That is, data corresponding to each item may be collected at the data collection time associated with each item.

The storage 111 includes a storage area for storing data collected by the data collector 113. For example, the storage 111 may store the data in the storage area in the order of being collected by the data collector 113.

The condition determiner 112 determines whether or not an industrial machine 20 is in operation. The operation means, for example, an operation of each component of the industrial machine 20. For example, in a case where the industrial machine 20 is not in automatic operation, the condition determiner 112 determines that the industrial machine is not in operation.

The automatic operation means that the industrial machine 20 operates based on a program including a plurality of lines generated in advance. During the automatic operation, an in-automatic operation signal is output from the numerical controller 21. That is, the term of being in the automatic operation may be referred to a period in which the in-automatic operation signal is output. In a case where the industrial machine 20 is a machine tool, the automatic operation means that the machine tool operates based on a machining program.

The automatic operation has a concept different from a Manual Data Input (MDI) operation in which a one-line code input by an operator is sequentially executed and a manual operation in which each control axis is operated by an operation of the operator on an operation pendant.

The condition determiner 112 determines that the industrial machine is not in operation, in a case where the machine tool is not in automatic operation or in a case where the automatic operation is temporarily stopped in a non-cutting block in which a workpiece is not machined.

The non-cutting block is a block that does not include a cutting feed command among a plurality of blocks constituting the machining program. Note that the block means a line in which a command is written in the machining program.

Examples of the cutting feed command include a linear interpolation command and a circular interpolation command. In the non-cutting block, a tool and a workpiece do not come into contact with each other, and the workpiece is not machined by the tool. The non-cutting block is, for example, a block in which an optional stop command M01 and a program stop command M00 are designated.

In a case where the condition determiner 112 determines that the industrial machine 20 is not in operation, the data collector 113 collects data from the numerical controller 21 that controls the industrial machine 20. The data collector 113 collects data to be collected from the numerical controller 21 based on the list of data stored in the storage 111.

In a case where the data collecting device 10 is connected to a plurality of numerical controllers 21, the data collector 113 may collect data from the plurality of numerical controllers 21.

The data collector 113 stores the collected data in the storage area of the storage 111. That is, the data collected by the data collector 113 is stored in the storage area of the storage 111.

Next, processing performed in the data collecting device 10 will be described.

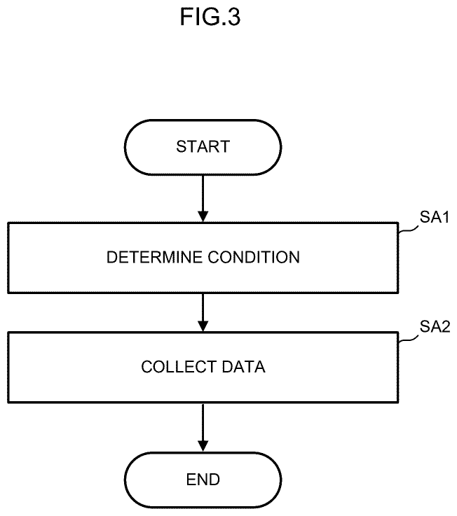

FIG. 3 is a flowchart illustrating an example of processes executed by data collecting device.

In the data collecting device 10, when the data collection time comes, the condition determiner 112 determines whether or not a condition is satisfied (Step SA1). Here, the condition is a condition for the data collector 113 to collect data. Specifically, the condition is that the industrial machine 20 is not in operation.

Then, in a case where the condition determiner 112 determines that the industrial machine 20 is not in operation, the data collector 113 collects data from the numerical controller 21 that controls the industrial machine 20 (Step SA2), and ends the processing.

As described above, the data collecting device 10 includes the condition determiner 112 for determining whether or not the industrial machine 20 is in operation, and the data collector 113 for collecting data from the numerical controller 21 for controlling the industrial machine 20, in a case where the condition determiner 112 determines that the industrial machine 20 is not in operation.

Thus, the data collecting device 10 can collect data when the access to the data on the numerical controller 21 is not restricted. As a result, the data collecting device 10 can reliably collect data to be collected from the numerical controller 21.

If internal data is collected during execution of a command to operate the industrial machine 20 with reference to the internal data, there is a concern that control based on the command is not correctly performed. However, the data collecting device 10 in the present disclosure collects data when the industrial machine 20 is not in operation. Thus, the control based on the command to operate the industrial machine 20 is correctly performed with reference to the internal data.

In addition, if a large amount of data is collected during the operation, the processing load of the numerical controller 21 increases. As a result, in a case where the industrial machine 20 is a machine tool that machines a workpiece, there is a concern that the quality of a machined surface of the workpiece is deteriorated such that a cutter mark is formed on the workpiece. However, the data collecting device 10 in the present disclosure collects data when the industrial machine 20 is not in operation. Thus, the data collecting device 10 does not have a concern that the quality of the machined surface of the workpiece is deteriorated.

Further, the condition determiner 112 determines that the industrial machine is not in operation, in a case where the machine tool is not in automatic operation or in a case where the automatic operation is temporarily stopped in the non-cutting block in which the workpiece is not machined. Thus, the data collecting device 10 does not stop the operation of the industrial machine 20 during the operation of the industrial machine 20, particularly, during machining of the workpiece. As a result, it is possible to prevent adverse influences on the machined surface of a workpiece, such as formation of a cutter mark on the workpiece.

Note that the condition determiner 112 may acquire data indicating at least one of the time at which the data collector 113 has started data collection and the time at which the data collector 113 has ended the data collection. Further, the condition determiner 112 may acquire data indicating the time at which the automatic operation is temporarily stopped in the non-cutting block. By utilizing such data, the operator or the like can analyze the operation status of the data collecting device 10.

The data collecting device 10 may further include at least one of a prohibition commander, a stop commander, and a restart commander.

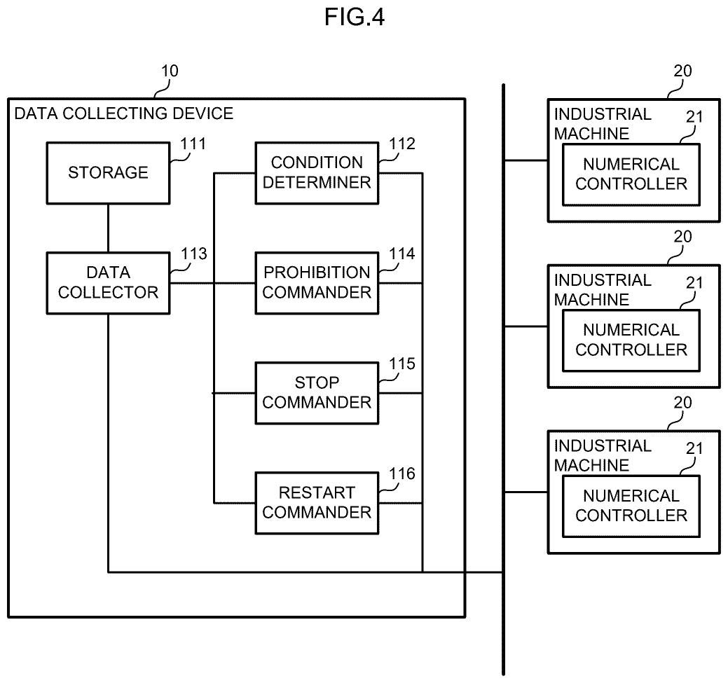

FIG. 4 is a block diagram illustrating another example of functions of the data collecting device 10. The data collecting device 10 includes a prohibition commander 114, a stop commander 115, and a restart commander 116 in addition to the functions illustrated in FIG. 2.

The prohibition commander 114 outputs a prohibition execution command for prohibiting the start and restart of the automatic operation and a prohibition release command for releasing the prohibition of the start and restart of the automatic operation. The start of the automatic operation means transition to an automatic operation state from a state where the automatic operation is not performed. The restart of the automatic operation means transition to the automatic operation state again from a state where the automatic operation is temporarily stopped. The prohibition execution command and the prohibition release command output by the prohibition commander 114 are transmitted to the numerical controller 21 via the network, for example.

The prohibition commander 114 outputs a prohibition execution command before the data collector 113 starts data collection. As a result, the start and restart of the automatic operation are prohibited in the numerical controller 21, and the data collector 113 turns into a state of being able to collect data.

In addition, the prohibition commander 114 outputs a prohibition release command after the data collector 113 ends data collection. As a result, the numerical controller 21 turns into a state where the automatic operation can be started and restarted.

The condition determiner 112 may acquire data indicating at least one of the time at which the data collector 113 has started data collection and the time at which the data collector 113 has ended the data collection. In this case, the condition determiner 112 may store data indicating the time at which the data collection has started and the time at which the data collection has ended, in the storage area of the storage 111.

The stop commander 115 outputs a stop command for temporarily stopping the automatic operation in the non-cutting block. In a case where the condition determiner 112 determines that the industrial machine 20 is in operation, the stop commander 115 outputs a stop command. As a result, the numerical controller 21 performs control to temporarily stop the automatic operation in the non-cutting block.

The stop commander 115 uses a stop command flag to store that the stop command has been output. That is, in a case where the stop commander 115 outputs the stop command, 1 is set to the stop command flag.

The restart commander 116 commands the restart of the automatic operation that has been temporarily stopped. The restart commander 116 commands the restart of the automatic operation after the data collector 113 ends the data collection. The restart commander 116 refers to the value of the stop command flag to determine whether the automatic operation of the industrial machine 20 is temporarily stopped or not in the automatic operation. In a case where the industrial machine 20 is not in the automatic operation, the restart commander 116 does not command the restart of the automatic operation.

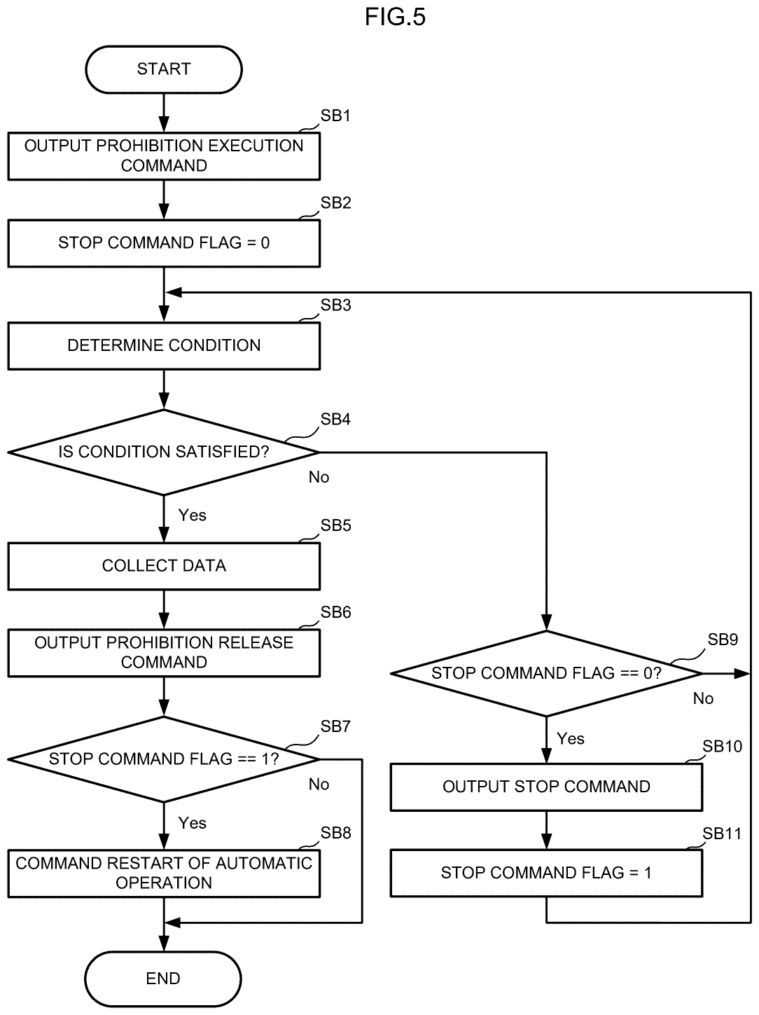

FIG. 5 is a diagram illustrating an example of a flow of processing performed by the data collecting device 10 illustrated in FIG. 4. When the data collection time comes, the prohibition commander 114 outputs a prohibition execution command for prohibiting the start and restart of the automatic operation (Step SB1).

Then, the stop commander 115 sets the stop command flag to 0 (Step SB2).

Then, the condition determiner 112 determines whether or not a condition is satisfied (Step SB3). The condition is a condition under which the data collector 113 starts data collection. Specifically, the condition is that the industrial machine 20 is not in the operation.

In a case where the condition is satisfied (if Yes in Step SB4), the data collector 113 starts data collection (Step SB5).

In a case where the data collector 113 ends the data collection, the prohibition commander 114 outputs a prohibition release command (Step SB6).

Then, the restart commander 116 determines whether the stop command flag is set to 1 (Step SB7).

In a case where the stop command flag is set to 1 (if Yes in Step SB7), the restart commander 116 commands the restart of the automatic operation (Step SB8).

In a case where the stop command flag is not set to 1 (if No in Step SB7), the restart commander 116 ends the processing without giving a command to restart the automatic operation. Note that, in a case where the stop command flag is not set to 1, the stop command is not output by the stop commander 115. In this case, the industrial machine 20 is not in the automatic operation.

In a case where the condition is not satisfied (if No in Step SB4), the stop commander 115 determines whether or not the stop command flag has been set to 0 (Step SB9).

In a case where the stop command flag has been set to 0 (if Yes in Step SB9), the stop commander 115 outputs a stop command (Step SB10).

Then, the stop commander 115 sets the stop command flag to 1 (Step SB11). Thereafter, the process of Step SB3 is started again.

In a case where the stop command flag is not set to 0 (if No in Step SB9), the process of Step SB3 is started again.

As described above, the data collecting device 10 further includes the prohibition commander 114 for outputting the prohibition execution command for prohibiting the start and restart of the automatic operation and the prohibition release command for releasing the prohibition of the start and restart of the automatic operation. In addition, the prohibition commander 114 outputs the prohibition execution command before the data collector 113 starts data collection. In addition, the prohibition commander 114 outputs a prohibition release command after the data collector 113 ends data collection.

Thus, it is possible to prevent the start or restart of the automatic operation when data is collected. Further, after the data collecting device 10 collects the data, the automatic operation of the industrial machine 20 can be started and restarted.

The data collecting device 10 further includes the stop commander 115 for outputting the stop command for temporarily stopping the automatic operation in the non-cutting block. In addition, in a case where the condition determiner 112 determines that the industrial machine 20 is in operation, the stop commander 115 outputs the stop command.

Thus, the data collecting device 10 can prevent the start of data collection during execution of cutting in the machine tool.

The data collecting device 10 further includes the restart commander 116 for commanding the restart of the automatic operation that has been temporarily stopped. In addition, the restart commander 116 commands the restart of the automatic operation after the data collector 113 ends the data collection.

Thus, the data collecting device 10 can restart the operation of the industrial machine 20 again after collecting the data.

Note that the condition determiner 112 may acquire the data indicating the time at which the automatic operation is restarted. By utilizing such data, the operator or the like can analyze the operation status of the data collecting device 10.

In the above-described embodiment, the data collecting device 10 is mounted on a personal computer. However, the data collecting device 10 may be mounted on the numerical controller 21 that controls the industrial machine 20.

In addition, in the above-described embodiment, the data collecting device 10 starts data collection at a predetermined data collection time. However, data collection may be started based on an operation of the operator. In addition, the data collecting device 10 may receive the operation of the operator for setting the data collection time or the like. In this case, the data collecting device 10 may include a Human Machine Interface (HMI) for receiving the operation of the operator.

Next, an example of a hardware configuration of the industrial machine 20 will be described.

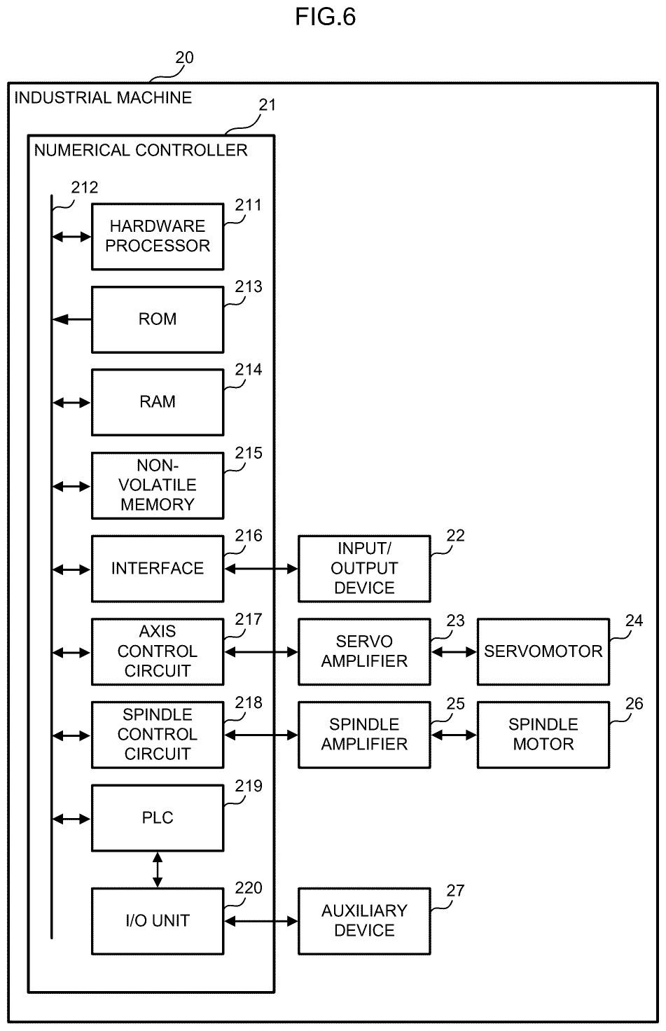

FIG. 6 is a block diagram illustrating the example of the hardware configuration of the industrial machine 20. The industrial machine 20 includes a numerical controller 21, an input/output device 22, a servo amplifier 23, a servomotor 24, a spindle amplifier 25, a spindle motor 26, and an auxiliary device 27.

The numerical controller 21 is a device for controlling the entire industrial machine 20. The numerical controller 21 includes a hardware processor 211, a bus 212, a ROM 213, a RAM 214, and a non-volatile memory 215.

The hardware processor 211 is a processor for controlling the entire numerical controller 21 in accordance with to a system program. The hardware processor 211 reads the system program stored in the ROM 213 via the bus 212, and performs various processes on the basis of the system program. The hardware processor 211 controls the servomotor 24 and the spindle motor 26 on the basis of an operation program. The hardware processor 211 is, for example, a central processing unit (CPU) or an electronic circuit.

The bus 212 is a communication path that connects the pieces of hardware in the numerical controller 21 to each other. Each piece of hardware in the numerical controller 21 transmits and receives data via the bus 212.

The ROM 213 is a storage device that stores, for instance, the system program for controlling the entire numerical controller 21. The ROM 213 is a computer-readable storage medium.

The RAM 214 is a storage device for temporarily storing various types of data. The RAM 214 functions as a work area for the hardware processor 211 to process various types of data.

The non-volatile memory 215 is a storage device for holding data even in a state where the industrial machine 20 is powered off and no power is supplied to the numerical controller 21. The non-volatile memory 215 stores, for example, the operation program and various parameters. The non-volatile memory 215 is configured by, for example, a memory backed up by a battery or a solid state drive (SSD).

The numerical controller 21 further includes an interface 216, an axis control circuit 217, a spindle control circuit 218, a Programmable Logic Controller (PLC) 219, and an I/O unit 220.

The interface 216 connects the bus 212 and the input/output device 22. The interface 216 transmits, for example, various types of data processed by the hardware processor 211 to the input/output device 22.

The input/output device 22 is a device for receiving various types of data via the interface 216 and displaying the various types of data. Furthermore, the input/output device 22 receives inputs of various types of data and transmits the various types of data via the interface 216 to, for example, the hardware processor 211.

The input/output device 22 is, for example, a touch panel. In a case where the input/output device 22 is a touch panel, the input/output device 22 is, for example, a capacitive touch panel.

The axis control circuit 217 is a circuit for controlling the servomotor 24. The axis control circuit 217 receives a control command from the hardware processor 211 and outputs a command for driving the servomotor 24 to the servo amplifier 23. The axis control circuit 217 transmits, for example, a torque command for controlling the torque of the servomotor 24 to the servo amplifier 23.

The servo amplifier 23 receives a command from the axis control circuit 217 and supplies a current to the servomotor 24.

The servomotor 24 is driven by receiving supply of the current from the servo amplifier 23. The servomotor 24 is connected to, for example, a ball screw for driving a tool rest. When the servomotor 24 is driven, a structure of the industrial machine 20 such as a tool rest moves in each control axis direction.

The spindle control circuit 218 is a circuit for controlling the spindle motor 26. The spindle control circuit 218 receives a control command from the hardware processor 211 and transmits a command for driving the spindle motor 26 to the spindle amplifier 25. The spindle control circuit 218 transmits, for example, a spindle speed command for controlling the rotation speed of the spindle motor 26 to the spindle amplifier 25.

The spindle amplifier 25 receives a command from the spindle control circuit 218 and supplies a current to the spindle motor 26.

The spindle motor 26 is driven by receiving supply of a current from the spindle amplifier 25. The spindle motor 26 is connected to a spindle and rotates the spindle.

The PLC 219 is a device for executing a ladder program to control the auxiliary device 27. The PLC 219 transmits a command via the I/O unit 220 to the auxiliary device 27.

The I/O unit 220 is an interface that connects the PLC 219 and the auxiliary device 27. The I/O unit 220 transmits a command received from the PLC 219 to the auxiliary device 27.

The auxiliary device 27 is a device that is installed at the industrial machine 20 and performs an auxiliary operation in the industrial machine 20. The auxiliary device 27 operates based on a command received from the I/O unit 220. The auxiliary device 27 may be a device installed around the industrial machine 20. The auxiliary device 27 is, for example, a tool changer, a cutting liquid injection device, or an opening/closing door drive device.

The present disclosure is not limited to the above embodiment, and can be appropriately changed without departing from the gist. In the present disclosure, any component of the embodiment can be modified, or any component of the embodiment can be omitted.

### REFERENCE NUMERALS LIST

10 Data collecting device
101 Hardware processor
102 Bus
103 ROM
104 RAM
105 Non-volatile memory
106 Interface
107 Input/output device
108 Communication device
111 Storage
112 Condition determiner
113 Data collector
114 Prohibition commander
115 Stop commander
116 Restart commander
20 Industrial machine
21 Numerical controller
211 Hardware processor
212 Bus
213 ROM
214 RAM
215 Non-volatile memory
216 Interface
217 Axis control circuit
218 Spindle control circuit
219 PLC
220 I/O unit
22 Input/output device
23 Servo amplifier
24 Servomotor
25 Spindle amplifier
26 Spindle motor
27 Auxiliary device

1. A data collecting device comprising:
a condition determiner for determining whether or not an industrial machine is in operation; and
a data collector for collecting data from a numerical controller that controls the industrial machine, in a case where the condition determiner determines that the industrial machine is not in operation.

2. The data collecting device according to claim 1, wherein the industrial machine is a machine tool for machining a workpiece.

3. The data collecting device according to claim 2, wherein the condition determiner determines that the industrial machine is not in operation, in a case where the machine tool is not in automatic operation or in a case where the automatic operation is temporarily stopped in a non-cutting block in which the workpiece is not machined.

4. The data collecting device according to claim 3, further comprising:
a prohibition commander for outputting a prohibition execution command for prohibiting start and restart of the automatic operation and a prohibition release command for releasing prohibition of the start and the restart of the automatic operation.

5. The data collecting device according to claim 4, wherein the prohibition commander outputs the prohibition execution command before the data collector starts collection of the data.

6. The data collecting device according to claim 4 or 5, wherein the prohibition commander outputs the prohibition release command after the data collector ends collection of the data.

7. The data collecting device according to any one of claims 3 to 6, wherein the condition determiner acquires data indicating at least one of a time at which the data collector has started collection of the data and a time at which the data collector has ended the collection of the data.

8. The data collecting device according to any one of claims 3 to 7, further comprising:
a stop commander for outputting a stop command for temporarily stopping the automatic operation in the non-cutting block.

9. The data collecting device according to claim 8, wherein the stop commander outputs the stop command in a case where the condition determiner determines that the industrial machine is in operation.

10. The data collecting device according to any one of claims 3 to 9, wherein the condition determiner acquires data indicating a time at which the automatic operation is temporarily stopped in the non-cutting block.

11. The data collecting device according to any one of claims 3 to 10, further comprising:
a restart commander for commanding restart of the automatic operation that has been temporarily stopped.

12. The data collecting device according to claim 11, wherein the restart commander commands the restart of the automatic operation after the data collector ends collection of the data.

13. The data collecting device according to claim 11 or 12, wherein the condition determiner acquires data indicating a time at which the automatic operation is restarted.

14. A computer-readable storage medium storing instructions for causing a computer to execute:
determining whether or not an industrial machine is in operation; and
collecting data from a numerical controller that controls the industrial machine, in a case where it is determined that the industrial machine is not in operation.
